(19) United States
(12) Patent Application Publication
(10) Pub. No.: US 2012/0085102 A1
(43) Pub. Date: Apr. 12, 2012

(54) METHOD FOR PURIFYING FLUE GASES OF A GAS ENGINE

(75) Inventors: Theodoor Petrus Knook, Hoofddorp (NL); Michiel Makkee, Rockanje (NL)

(73) Assignee: Theodoor Petrus Knook, Hoofddorp (NL)

(21) Appl. No.: 13/262,736

(22) PCT Filed: Apr. 6, 2010
(86) PCT No.: PCT/NL10/50179

§ 371 Date: Dec. 27, 2011

(30) Foreign Application Priority Data
Apr. 3, 2009 (NL) 2002711

(51) Int. Cl. F02C 7/00

(52) U.S. Cl. 60/783

(57) ABSTRACT

The invention relates to a method for removing methane from the flue gases of a gas engine, wherein the flue gases are conducted at a temperature of at most 5000 C over a noble metal catalyst, comprising a noble metal on a solid oxidic support, under conditions where no poisoning or inhibition of the noble metal catalyst by SO2 and/or NOx occurs.

The invention relates to a method for removing methane and possibly other harmful components from flue gases of a gas and/or biogas engine, so that these flue gases become suitable to be used as CO₂ for horticultural crops.

There is an increasing need to purify flue gases from engines, more particularly (bio)gas engines, to a far-reaching extent. Typically, these flue gases still contain organic compounds, such as methane and ethylene, as well as inorganic compounds, such as sulfur oxides (SO₂), nitrogen oxides (NOₓ) and carbon monoxide.

The emission of methane to the environment is undesirable, since this is a greenhouse gas.

As is known, it is desirable to supply CO₂ to horticultural greenhouses as a carbon source for the growth of the plants. This can be done via gas pipes, through separate supply with tank trucks and/or storage in containers. Often, it is endeavored to use CO₂ from gas engine flue gases which are used for combined heat and power (CHP) cogeneration at the greenhouse.

For this use of flue gases as a CO₂ source in greenhouses, it is desirable that the flue gases contain as few pollutants as possible, in particular, that they contain as few sulfur oxides, nitrogen oxides, methane and ethylene as possible. Also for emission of the flue gases to the atmosphere, it is desirable that the content of pollutants be as low as possible.

It is known in fact that the sulfur oxides and nitrogen oxides have an adverse effect on crop growth, and that ethylene is a growth hormone for plants. Too much ethylene in (horticultural) greenhouses can lead to soft crops with fruits ripening too soon and too fast.

Many gas engines exhibit some extent of slip of the fuel gases, being mostly biogas or methane. For this reason, it is usual to treat the flue gases further by conducting them over an oxidation catalyst.

It is known to purify flue gases of methane and nitrogen oxides utilizing a methane oxidation catalyst based on palladium on alumina in the presence of an oxygen storage material such as ceria or ceria-zirconia. Further, preferably, an H₂S scavenger is used in the catalyst. The temperature for this oxidation is at least 600° C. or higher (WO 2007/087725).

Wang et al. (Low temperature complete combustion of methane over titania-modified alumina supported palladium, Fuel 81 (2002) 1883-1887) describes the positive effect of titania on the action of a palladium catalyst on the oxidation of methane at a temperature of less than 700° C., with proportionally high methane contents and long residence times.

As the exhaust gases of a modern gas engine generally have a temperature of about 400 to 500° C., the known methods require much energy to adjust the whole gas flow to the desired temperature.

Also, there is a need for a system that with low concentrations of reactants (oxygen and methane) and with a short contact time (high GHSV) gives a good conversion of methane (and other organic compounds).

It is a first object of the invention to provide a method for removing methane from flue gases of a gas engine, which method is energetically favorable. Further, it is an object to provide a method whereby in addition to methane also other harmful gases, such as ethylene, nitrogen oxides and sulfur oxides are removed.

In the exhaust gases of a gas engine that is fueled with methane and/or biogas, approximately 40 ppm of ethylene is present. Currently, it is assumed that an ethylene content in flue gases for horticultural applications (greenhouses) of 400 ppb ppm is still allowable. However, upon the transition to closed systems this has been found to be the case no longer and a considerably lower maximum needs to be used. It is therefore a further object of the invention to also remove ethylene, simultaneously with the removal of methane, preferably to a level below 100 ppb, preferably to a level below the current detection limit of 10 ppb.

At lower temperatures, the methane conversion over an oxidation catalyst diminishes in case nitrogen oxides, water or sulfur oxides are present.

The invention now concerns a method for removing methane from flue gases of a gas engine, wherein the flue gases are conducted at a temperature of at most 500° C. over a noble metal catalyst, comprising a noble metal on a solid oxidic support, under conditions where no poisoning or inhibition of the noble metal catalyst by SO₂ and/or NOₓ occurs.

Surprisingly, it has been found that it is possible in this way to purify flue gases of methane and also ethylene very efficiently, whereby the removal percentages are at a very high level and remain so. Especially the removal of methane is very important from an environmental point of view, as the emission of methane by glass horticulture already accounts for 2% of the total emission of greenhouse gases in the Netherlands.

In order to obtain the conditions for preventing poisoning or inhibition of the noble metal catalyst, various methods are available. A first possibility is to make use of the (proven) reversibility of the inhibition and poisoning, which means that by alternating removal and regeneration of the system sufficiently fast, no permanent inhibition or poisoning occurs. If after 15 minutes at most, preferably after 7 minutes at most, the oxidation phase is stopped and regeneration is done, a system is obtained that remains operational in a very reliable manner for a very long time, with which the flue gases are also cleaned in a very far-reaching manner.

A second variant is formed by removing the nitrogen and/or sulfur oxides from the flue gases, before they reach the noble metal catalyst. To this end, use can be made of current adsorption systems, preferably under oxidic conditions, for these compounds.

In a third variant, the two systems are combined.

In the method according to the invention, as a noble metal catalyst, preferably a palladium and/or platinum catalyst on a titania or alumina support is used. This support is preferably present as washcoat in a monolith.

If desired, the catalyst may be promoted with copper. In that case, it is preferred for the promoting component to be applied after application of the noble metal.

Surprisingly, it has further been found that it is preferable for the activation of the catalyst to be done at a comparatively low temperature, viz., roughly the same temperature as the application. Activation or calcination is simply done in air at 350 to 500° C., or with flue gas, in the same temperature range. This has the additional advantage that no separate heating step is necessary, while furthermore in this manner the catalyst is more active and has a longer effective life.

In the practice of the method according to the invention utilizing a relatively quick alternation of oxidation and regeneration phases, it is preferred to choose a duration of each phase that is so short that no irreversible inhibition or poisoning of the catalyst (and any adsorbents present) occurs.

Regeneration takes place under reducing circumstances, for example by treatment with CO and/or H_{2.}

Both the removal of methane and possibly ethylene, and the optionally used adsorption of nitrogen and sulfur oxides, take place under oxidative circumstances. In the gas mixture, oxidizing conditions then prevail, preferably an excess of oxygen with respect to the components to be oxidized.

In case adsorbents for nitrogen and sulfur oxides are present, then, for the removal of SO₂, a Pt, for example a Pt/Cu on titania system is used. Adsorption takes place under oxidizing conditions, the following two reaction schemes being representative of the removal and desorption.

Adsorption of SO₂ (oxidizing conditions; Pt/Cu on a titania washcoat)

SO₂+1/2O₂+Pt+Sorber - - - >Sorber-SOₓ+Pt

Desorption (reducing conditions)

Sorber-SOₓ+H₂+CO+Pt→Sorber+SO₂+H₂O+CO₂+Pt

For the removal of NOₓ(NO) a comparable reaction scheme applies, where as adsorbent a Pt/K₂CO₃ on an alumina washcoat is used

2NO+3/2O₂+Pt+K₂CO₃2KNO₃+Pt+CO₂

Desorption (reducing conditions)

2KNO₃+Pt+CO+4H₂→K₂CO₃+N₂₊4H₂O+Pt

The catalyst is provided on a support, whose surface consists substantially of titania or alumina. It may therefore be a support consisting wholly of titania or alumina, but it is also possible that a support is used whose surface consists substantially of titania, for example a solid oxidic support or metal having on the surface thereof a layer of titania or alumina. As support, preformed particles, powder or extrudates can be a starting point, but also a structured support, such as a monolith having a washcoat of titania or alumina or a metal or ceramic foam with such a washcoat.

The amounts of noble metal, preferably palladium and/or platinum, can vary within broad limits, depending on the desired use and the desired activity. One skilled in the art can determine these values experimentally. Preferably, the amounts of noble metal are 0.05 to 10% by weight, with a preference for the range of 0.1 to 2.5% by weight, based on the weight of the support and the active metal.

It has been found that it is possible to include a promoter in the same catalyst. This promoter is preferably copper, zinc or nickel.

The amount of promoting metal is generally 0.1 to 10% by weight, more particularly 0.1 to 3% by weight, with respect to the weight of support and active components (noble metal and promoter).

The manufacture of the catalyst that is used according to the invention can be done, inter alia, utilizing known techniques, such as impregnation, (deposition or incipient wetness) precipitation, or by applying a washcoat, or chemical gas phase deposition, electric spray deposition, etc.

The invention shows its merits to advantage, more particularly, in case the amount of reactants is low, that is, if the content of organic material is 5000 ppm or less and the oxygen content is less than 15% by volume.

The invention is preferably used for the treatment of flue gases of gas engines. To be considered in this connection are, for instance, engines with powers of from 1 MWe to 22 MWe, flue gas flow rates in the range of from 5,000 kg/h to 110,000 kg/h, with temperatures of between 300 and 500° C.

The invention will now be elucidated in and by Examples, which should not be construed as limiting.

### Examples

In all Examples the gas phase consists of 1,000 ppm of methane, 40 ppm of ethylene, 11.5 ppm of SO₂, 300 ppm of NOₓ, 50,000 ppm of CO₂, 100,000 ppm (10% by volume) of O₂ and helium makes up the balance.

The amount of catalyst is chosen such that the gas phase has a residence time of 60,000 liters of gas per liter of catalyst per hour. Depending on the circumstances, upstream of the methane catalyst a bed of sulfur capture material or NO capture material or both sulfur capture and NOₓ capture material is mounted. The conversion of ethylene to CO₂ is complete in all cases. Only the conversion of the methane as a function of the temperature and/or time is described in the Figures. The catalysts have been prepared with a cake-forming impregnation and thereupon dried at 80° C. and pretreated in air at 400° C.

The S-trap is a commercially available trap based on platinum+copper on a titania support. The N-trap is a commercially available trap based on platinum+potassium carbonate on an alumina support.

### Example 1

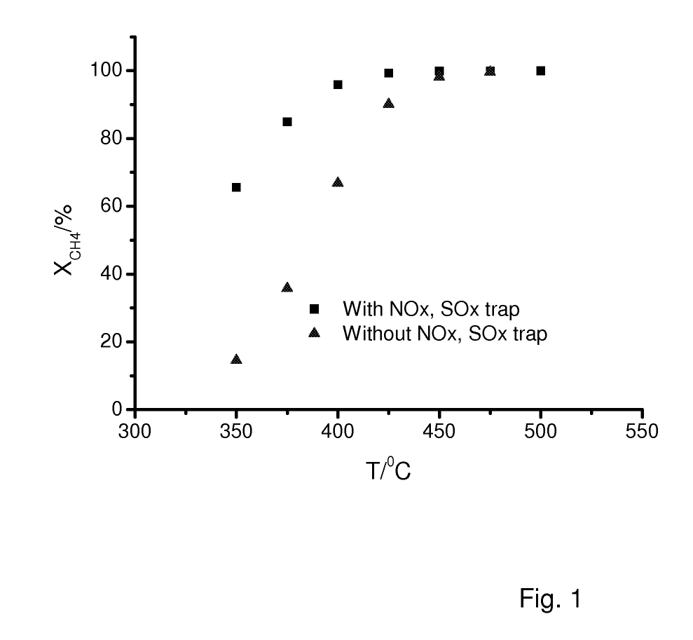

In FIG. 1 the conversion of methane over a 1% Pd-1% Pt on γ-alumina (specific surface of 300 m² per gram) is represented as a function of the temperature, with a sulfur trap and Nox trap upstream. As soon as the sulfur trap and the Nox trap are taken from the gas flow, the activity of the catalyst decreases strongly. Putting the sulfur and Nox trap back has no effect on the activity of the catalyst anymore. The methane catalyst is irreversibly deactivated.

### Example 2

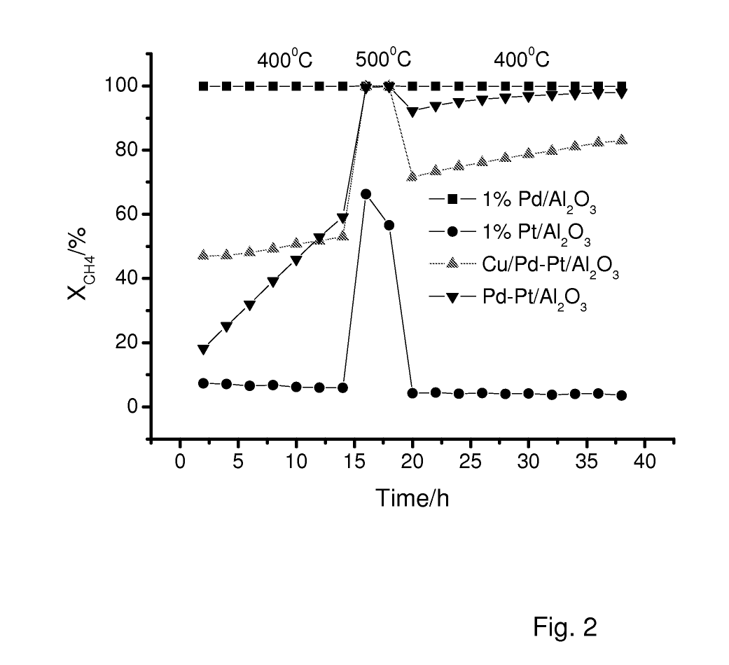

In FIG. 2 the methane conversion is followed as a function of time. Before the methane catalyst, both the sulfur trap and the NOₓ trap have been connected. The palladium catalyst (1% Pd on γ-alumina; specific surface of 300 m² per gram) is active directly at 400° C. An interim temperature of 500° C. has no influence on the action of this palladium catalyst. The platinum catalyst (1% Pt on γ-alumina; specific surface of 300 m² per gram) has a significantly lesser activity (<10%). An interim temperature towards 500° C. gives a higher methane conversion. Upon a return to 400° C., the platinum gives a low activity (<10%). For a copper-palladium catalyst (1% Pd and 0.2% Cu on γ-alumina; specific surface of 300 m² per gram) the methane conversion as a function of time goes up at 400° C. At a temperature of 500° C. the methane conversion is complete. Upon the return to a temperature of 400° C., for the copper-palladium catalyst the activity of the methane conversion continues to rise over time. For a palladium-platinum catalyst (1% Pd and 1% Pt on γ-alumina; specific surface of 300 m² per gram) the activity of the methane conversion increases. The activity of this catalyst compared to the copper-palladium catalyst is lower and the rise in the activity as a function of time, however, is stronger. An interim temperature of 500° C. for this palladium-platinum catalyst (1% Pd and 1% Pt on γ-alumina; specific surface of 300 m² per gram) leads to complete conversion at 400° C.

1. A method for removing methane from the flue gases of a gas engine, wherein the flue gases are conducted at a temperature of at most 500° C. over a noble metal catalyst, comprising a noble metal on a solid oxidic support, under conditions where no poisoning or inhibition of the noble metal catalyst by SO₂ and/or NOₓ occurs.

2. A method according to claim 1, wherein the noble metal catalyst is selected from palladium and/or platinum, optionally promoted with copper and provided on an oxidic support.

3. A method according to claim 1, wherein the temperature is at most 450° C., more particularly at most 400° C.

4. A method according to claim 1, wherein said conditions where no poisoning or inhibition of the catalyst occurs are obtained by upstream removing of NOₓ and/or SO₂ from the flue gases.

5. A method according to claim 1, wherein said conditions where no poisoning or inhibition of the catalyst occurs are obtained by first oxidizing the flue gases over the noble metal catalyst, and the catalyst before it is poisoned or inhibited is desorbed.

6. A method according to claim 4, wherein the catalyst before it is poisoned or inhibited is desorbed.

7. A method according to claim 5, wherein oxidizing is done for at most 15 minutes and thereupon desorbing is done for approximately the same time.

8. A method according to claim 7, wherein this time is at most 10 minutes, more particularly at most 7 minutes.
